(19) United States
(12) Patent Application Publication
(10) Pub. No.: US 2017/0169290 A1
(43) Pub. Date: Jun. 15, 2017

(54) Method for Automatically Establishing a Data Record Characterizing Two Technical Drawings

(71) Applicant: Siemens Aktiengesellschaft, Muenchen (DE)

(72) Inventors: Harald HELD, Bockhorn (DE); Hermann Georg MAYER, Prien am Chiemsee (DE); Efrossini TSOUCHNIKA, Muenchen (DE); Klaus WENDELBERGER, St. Leon-Rot (DE)

(73) Assignee: Siemens Aktiengesellschaft, Munchen (DE)

(21) Appl. No.: 15/306,409

(22) PCT Filed: Apr. 21, 2015
(86) PCT No.: PCT/EP2015/058563

§ 371 Date: Jan. 5, 2017

(30) Foreign Application Priority Data
Apr. 25, 2014 (DE) 10 2014 207 870.9

(51) Int. Cl. G06K 9/00; G06F 17/50; G06K 9/20; G06K 9/62; G06K 9/46

(52) U.S. Cl. CPC G06K 9/00476; G06K 9/6215; G06K 9/46; G06K 9/4638; G06K 9/6288; G06K 9/2009; G06F 17/509; G06K 2009/4666; G06K 2209/01

(57) ABSTRACT

A method implemented in a computer system for automatically establishing a data record from two technical drawings, where the data record characterizes the two technical drawings that include symbols and lines connecting the symbols.

### CROSS-REFERENCE TO RELATED APPLICATIONS

This is a U.S. national stage of application No. PCT/EP2015/058563 filed 21 Apr. 2015. Priority is claimed on German Application No. 10 2014 207 870.9 filed 25 Apr. 2014, the content of which is incorporated herein by reference in its entirety.

### BACKGROUND OF THE INVENTION

1. Field of the Invention

The invention relates to a method performed in a computer system for automaticlly establishing a data set characterizing two technical drawings having symbols and lines joining the symbols, from the technical drawings, comprising the following method steps:

a) scanning the technical drawings, and

b) identifying a symbol in the first technical drawing and storing a node representing the symbol in the data set,

2,. Description of the Related Art

Within a collection of related documents (in particular in document collections not electronically stored), referencing systems are often present, by which referencing can occur from one document to another. In the case of purely text documents, the referencing is typically very simple in that, for example, reference can be made with a generally understood reference to other text parts (e.g., “see chapter 12, first paragraph”).

In more strongly formalized document collections, such as formulary collections or legal texts, the type of referencing can assume complex forms and contain, for example; conditional references (“if velocity close to c, then relativistic calculation, see formula y, otherwise, formula z”) or relate to the preceding context (e.g., “if it is determined from §x that the purchaser is not legally competent, then also take account of §y”).

Similar references are found on printed construction and circuit plans, i.e., technical drawings. These serve to describe complex correlations and processes in technical plants and equipment. Drawings of this type are to be found, inter alia, in function charts for the description and creation of automation functions, such as are described in WO 2013/092654 A1. Typical properties of such drawings are that there, are particular symbols which are linked to one another by lines.

The technical drawings are typically optimized therefor that for a human observer, a particular aspect, a module or an assembly is summarized on one page which itself is bound into an overall system by references to other pages. It is thus conceivable, for example, that the circuit diagram of a computer is separated into a page for the central processing unit, a page for the graphics chip and a page for the input/output unit. Herein, numerous connections must, be linked to one another, possibly over a plurality of pages, in order to obtain a functional overall system.

For the production of the overall system (e.g., for a circuit board exposure device), the description of the overall system must be brought together to a unit in a machine-readable form. This task is particularly challenging if modules with different connection specifications from different manufacturers are to be brought together in an overall system, it can also occur that a part of the plans is already present in digital form (e.g., a new processor), while the remainder of the system, which is to be modernized, is still present in the form of printed plans.

The scanning and vectorization of technical drawings in a sufficiently high quality, including text recognition (OCR) is possible without difficulty today. For this purpose, the diagrams are scanned so that they are present as raster graphics and are converted using modern software tools into vector information and text. Starting from this vector information (following optional pre-processing) symbol candidates can be filtered out from all the lines (e.g., using rules or searches for rectangles; see e.g. Y. Yu, A. Samal, S. C. Seth: A System for Recognizing a Large Class of Engineering Drawings. IEEE Trans on PAMI19:8, 868-890 (1997) and S, Adam, J. M. Ogier, C. Cariou, R. Mullet, J. Labiche, J. Gardes: Symbol and character recognition! application to engineering drawings. IJDAR 3, 89-101 (2000)) and connecting lines between the symbol candidates can be identified.

In this way, a representation is finally obtained as a graph (in the mathematical sense) that describes the symbols and their connections to one another, specifically for each processed page. This graph, the node of which describes the symbols, forms a data set that can be used for further processing. The lines between the symbols are stored in the data set as connections with end points, where the end points are associated with the respective nodes that are connected by the line.

However, the methods outlined do not solve the problem mentioned in the introduction of referencing between a plurality of technical drawings. If the document collections are not present in digital form or at least the references are not present in a machine-readable form (e.g., in the forts of HTML hyperlinks), it has conventionally been necessary for the documents and particularly their references to be converted manually into a machine-readable form, because often only a user with knowledge of the domain knows and can correctly resolve the semantics of different types of references.

The conventional method is therefore typically very time and labor-intensive and therefore costly. In addition, the documents (in this case plant plans) often consist of several thousand pages, so that the manual processing or merging of the results of a plurality of processing persons is fault-prone. A significant effort is therefore involved for checking the results and for the correction of errors.

### SUMMARY OF THE INVENTION

It is therefore an object of the invention to provide a method with which references between a plurality of technical drawings can be extracted automatically from vectorized data of the technical drawings.

This and other objects and advantages are achieved in accordance with the invention, by a method including the following further method steps of identifying an open line in the first technical drawing originating from the symbol, where a first connector is associated with, an open end point of an open line and is stored in a data set identifying a pattern characterizing the open end point in a defined pattern search region and associating the pattern with the first connector, and associating the first connector with a second connector of the second technical drawing based on the associated patterns for the first connector and the second connector.

The invention is based on the consideration that an automatic referencing of a plurality of drawings between one another could be achieved in that the respective contact points provided with references are initially automatically recognized. In technical drawings, references to other pages are typically situated, at open ends of connections. As a result, this can occur by recognizing such open lines originating from a symbol. A “connector” is then associated with the graphically localized end point of the connection, where the connector essentially contains a reference to another connector on another technical drawing and is stored in the data set of the drawing. In order to associate the connector thus found with another connector of another drawing and to complete the reference, a pattern search region is then defined in which a pattern, characterizing the open end point is sought, which means, for example, a text or a graphic that identifies the reference in (written) image form. As soon, as the pattern is found, a comparison with other patterns of other connectors can occur so that two connectors can be associated with one another.

Advantageously, in the data set, the association of the first connector to the second is subsequently replaced through the. storage of a connection, where the connection exists between the symbol to which the corresponding connector of the first drawing is connected and the symbol from the second technical drawing from which the open line with the open end point originates, which is associated with the second connector. In other words, connections between compatible connectors are (depending on use) automatically completed, i.e., the connectors are removed and a corresponding connection is inserted, where the end points of the new connection correspond to the respective end points of the connections linked at the connector, with this, a monolithic data set comes about which no longer reflects the page structure present in paper form.

In order, when using the method, to also perform more complex, assemblies of documents fully automatically in which the references are identified by particular application-specific symbols and rules, the corresponding domain knowledge of the expert should further be formalized in order to record different syntactical versions of the same semantics. For this purpose, ontology data is prepared that comprises a plurality of ontology terms with, respectively associated property data, where one of the ontology terms is associated with the connector. In other words, for each specific use, an ontology is defined that makes available a linguistically formulated and formally ordered representation of the terms occurring and the semantic relationships existing between them. The ontology defines particular ontology expressions of which particular pre-defined properties are characteristic, so that open line ends that are found in the technical drawing are associated with a particular ontology expression based on their properties and are correctly interpreted. Thus, for example, in a particular technical drawing, a leftwardly open line end might be a signal input that refers to a signal, output on another page. For another type of technical drawing, the semantics of a leftwardly open connection can be entirely differently defined. Such differences can be stored in a corresponding ontology so that with, this, the semantics can be freely defined and the respective correct meanings can be associated with the different types of line ends. The expressions stored in the ontology can be for technical function charts, such as “global input reference”, or “local output reference”.

Equally as important as the correct interpretation of the content of the references is the finding thereof in the technical drawings. While this can typically be relatively easily described for purely text documents (e.g., with the aid of regular expressions (e.g., REFERENCE=“ref.”/“cf.”/“see”)), the finding of references in graphical documents (e.g., circuit plans or plant plans) is distinctly more difficult because the pattern search regions in which particular reference patterns must be sought can be different according to the application. In the context of the ontology definition described, however, this can be achieved in that advantageously the property data of the ontology expressions contains a number of anchor points with respectively associated anchor localization data that contains a localization of the respective anchor point in relation to the open end point of the line in the technical drawing. This means that for a particular ontology expression, e.g., the aforementioned “local input reference”, localization data is stored that finds an anchor point in relation to the line end in the technical drawing. With this based on, for example, the data stored in the ontology for each local input reference in the technical drawing, an anchor point which is always similarly localized can be found, the coordinates of which form the basis for the pattern search region in which a pattern for the reference is sought.

In an advantageous embodiment of the method, the anchor localization data herein contains definitions for a vertical and a horizontal line, at the intersection point of which the anchor point is localized. Technical drawings and particularly, for example, circuit plans are normally drawn based upon an orthogonal pattern in which lines that connect the individual symbols typically extend either vertically or horizontally. Consequently, a grid of this type is also ideally suited to the finding of an anchor point. In particular, herein the references are also typically oriented to this grid. Advantageously, herein the definitions of the lines are selected from the following possibilities:
a line at a fixed position, i.e., a pre-defined line at a particular location of the technical drawing, such as the line f(x)=10. This can be the case, for example, if all the references are collected in a particular region of the drawing, such as at the left edge, regardless thereof in which region the actual line identified by the reference ends; the closest line in relation to the open end point, i.e., starting from the line end, the closest horizontal or vertical line is sought; the normal at the open end point of the open line; and the extension of the open line.

The selection possibilities cited, offer patterns based on which the usual conventions in technical drawings for the arrangement of references can be depicted digitally. This enables a particularly simple automation of the recording of these references.

In a further advantageous embodiment, the property data further contains a number of the pattern search regions with, respectively associated pattern localization data that contains a localization of the respective pattern region in relation to the respective anchor point. In other words; stored in the property data is pattern localization data that defines the position and size of the pattern search region in relation to the respective anchor point, so that it can be defined, for example, that the pattern search region should comprise, originating from the anchor point, an area of between 0 and 40 pixels horizontally and between 0 and 40 pixels vertically. The orientation of the pattern search region can also be dependent on the orientation of the open line. For each anchor point, it should be understood, any desired number of regions in which patterns are sought, can be defined.

The property data advantageously further contains pattern definitions for patterns to be sought in the respective pattern search region. The pattern definitions thus effectively contain the structure of the respective references. The reference can herein be defined in text form or graphically. The pattern can also consist of many parts. For graphical patterns, herein image portions can be stored. For references in text form, regular expressions can be specified, i.e., character strings that define particular syntactical rules that correspond to the respective references. With a markup language (e.g., XML), properties can be given for parts of the defined pattern. The pattern in a region can consist of a plurality of portions for which different properties are defined, or property groups can be defined. With this, complex tree-like structures can be constructed for patterns.

In an advantageous embodiment, the respective pattern search region can herein be restricted based on previously recognized, patterns, i.e., as soon as the pattern search region for the respective anchor point is defined, and corresponding pixel coordinates exist, a test is performed to determine whether other patterns (e.g. references) from previous recognition processes have been detected within the pattern search region. If this is the case, the region in which these previously recognized patterns lie is subtracted, i.e., excluded, from the pattern search region. The recognition then still occurs only in the remaining region.

In a further advantageous embodiment, the method further comprises identifying all the symbols in the technical drawing and storing a respective node representing each symbol in the data set, and identifying lines respectively connecting at least two symbols in the technical drawing and storing connections representing the respective line in the data set.

Here, at least two end points are associated with each connection and one of the nodes that represent the symbols connected by the respective line is associated with each end point. In other words, the method records not only the open lines in the technical drawing and the symbols connected thereto, but rather all the symbols and lines of the technical drawing and stores these in the data set in the manner of a graph (in the mathematical sense). This is already known from the publications cited in the introduction. In the present method, however, the advantage hereby arises that the recognition of the open lines is simplified and thus a higher level of accuracy is achieved. Specifically, if the elements on one page of, for example, a circuit plan are automatically recognized (rectangles as modules and orthogonal lines therebetween as connections), then all the open line ends without a connection to a module remain as candidates for a reference definition. The method described is then performed on these remaining candidate lines.

Furthermore, this also enables an improvement with regard to the pattern recognition. The respective pattern search region is restricted for this purpose by already recognized symbols and/or lines. Similarly to the exclusion of previously recognized patterns, herein as soon as the pattern search region for the respective anchor point is defined and corresponding pixel coordinates exist, a teat is performed to determine whether previously recognized symbols and/or lines lie within the pattern search region. If this is the case, the region in which these previously recognized symbols and/or lines lie are subtracted, i.e., excluded, from the pattern search region. For lines, herein for example a particular thickness of the region that will be excluded round the line can be defined. The recognition then still occurs only in the remaining region.

Finally, the property data that is associated with the respective ontology expressions comprises information that determines that ontology expression must be associated with the second connector, so that an association of the first to the second connector is permitted. The ontology thus comprises information items concerning the connecting possibilities, depending on the use. Hereby errors are prevented: in certain circuit plans, it can be a conventions for example, that a leftwardly open line end is a signal input that refers to a signal output on another page. This is stored in the property data for the ontology expression “signal input”. During the allocation of the connectors to one another, a test is performed to determine whether the corresponding condition, is fulfilled. If it cannot be fulfilled because no suitably fitting connectors to the respective other side exist, an error is output. Whether errors of this type arise due to an erroneous recognition or from already faulty documents plays no part herein. In each case, a manual intervention is advisable. The relevant user can thus be informed, with specification of the symbols involved, the document and also the connectors involved.

It is also an object of the invention to provide a computer program product that can be loaded directly into the internal memory of a computer that advantageously comprises software code portions with which the disclosed embodiments of the method described is performed when the computer program product executes on the computer.

A computer system advantageously comprises a scanner and an internal memory into which a computer program product of this type is loaded.

The advantages achieved with the invention lie particularly therein that, via an automated pattern recognition and association in the digitization based on pre-defined pattern search regions, an automatic harmonization of technical documents distributed over a plurality of pages of technical documents is enabled. In contrast to rigid digitizing systems that are concerned with a particular category of documents, with the system described, it is possible to react flexibly to different manifestations of references between documents.

The information items that are needed for triggering the reference can originate from any desired state in the document and can be brought together flexibly to an unambiguous entity. In particular with the system, documents that were generated with different reference systems (e.g., during the modernization of stock facilities) can ha connected to one another and can thus be prepared for further automatic processing (e.g., circuit board printing). With this, a significant time saving is achieved as compared with manual transfer.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the invention will now be described in greater detail making reference to drawings, in which:

FIG. 1 is a schematic flow diagram of a method for automatically establishing a data set characterizing two technical drawings having symbols and lines joining the symbols;

FIG. 2 is a portion of a technical drawing;

FIG. 3 is a pattern search region with an anchor point;

FIG. 4 is a symbolic representation of possibilities for finding lines for localizing the anchor point;

FIG. 5 is the drawing of FIG. 2 with lines drawn in accordance with an ontology;

FIG. 6 is the drawing of FIG. 5 with anchor points in accordance with an ontology expression and

FIG. 7 is the drawing of FIG. 6 with restricted pattern search regions.

### DETAILED DESCRIPTION OF THE EXEMPLARY EMBODIMENTS

The same components are provided with the same reference numerals in all the figures.

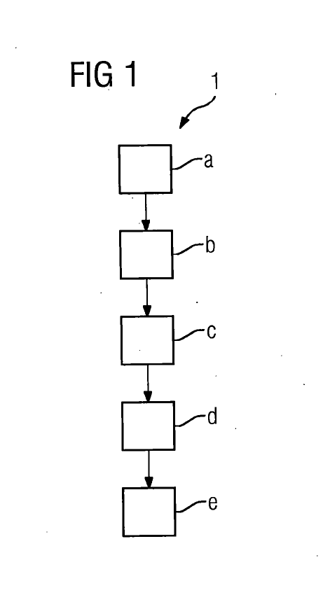

FIG. 1 shows a schematic flow diagram of a method 1 for automatically establishing a data set characterizing at least two technical drawings having symbols and lines joining the symbols. The basis hereof is therefore a plurality of technical drawings. A technical drawing is, in general, a document that contains all the necessary information items for the generation and description of the required functions and properties of a single part, an assembly or a complete product in graphical and written form and serves as part of the technical product documentation. In general, particularly for relatively complex systems, such as entire manufacturing plants, many hundreds and thousands of pages of such technical, drawings exist. These are characterized in that they consist of symbols that represent, for example, individual components of the plant as well as lines between the symbols which represent operative connections, such as a current or data transmission.

All the steps of the method shown in FIG. 1 are implemented in a computer system (not shown in detail) which is made suitable for performing the steps of the method in accordance with the invention. In particular, a computer program is loaded into the memory of the computer system, comprising software code portions that cause the computer system to perform the method.

In step a), the technical drawings are first scanned. This includes all the pages of the technical drawings, which thus are digitally recorded. For further processing, the scanned image files are vectorized, i.e., in each generated raster image, simple geometric objects are identified during the vectorization. This can occur with common variants from the prior art known to persons skilled in the art, e.g. via edge detection, regions of the same or similar lightness or color, also known as posterization, can be detected. The final result is coordinate data of graphic primitives in the technical drawing, i.e., lines, open or closed curves, points, and the like.

Prom the vector graphics, following on from step b), the symbols are identified in the technical drawing, i.e., their number and position. In the data set to be generated that is to represent the technical drawing, representative nodes are now stored for each symbol. A data subset therefor forms for each symbol on the respective page.

In step c), which can also occur simultaneously with step b), each of the lines in the technical drawing are identified and. connections representing each line are stored in the data set. This applies both for the lines between two symbols and also for open lines without a terminating symbol on one side. Herein, at least two end points are associated with each connection. For lines joining symbols, one of the nodes that represent the symbols connected by the respective line is associated with each end point. For open lines, the node of the respective symbol from which the line originates is associated with an end point. Associated with the open end point of the line is a “connector”, which therefore, similarly to nodes, identifies the end point of the line in the data set, but explicitly indicates an open line end that is continued at another site of the technical drawing or in another technical drawing. Herein, lines with two open ends are also possible, i.e., that have an open connector at both ends. This is sometimes handled in order to provide the line with further semantics if required.

Finally, a graph in the mathematical sense is produced for each individual page of the technical drawings that comprises nodes and connections, where the end points of open lines in the technical drawings are stored as connectors, i.e., in the mathematical sense as nodes of the graph separately shown as connectors from which only a single connection (representing the open line) originates. Subsequently, a classification of the symbols can also occur with respect to which different ways and means are known to persons skilled in the art, e.g., from the publications cited In the introduction. However, in the following, it is not the classification of the symbols, but the association of the connectors with one another that is described.

The connectors correspond to open line ends that are to be continued to particular other open line ends, in particular on other technical drawings or pages. For this purpose, corresponding references are given in the technical drawings, enabling a precise allocation of the open line ends to one another. In step d), for each connector, a pattern characterizing the open end point is sought in a defined pattern search region in the drawing and is associated with the corresponding connector. This is described in more detail with reference to the following figures.

Based on the associated pattern (together with corresponding semantic information items) connectors can also be associated with one another on the digital level. Thus, connections between the connectors of the individual graphs of each page are defined. If the association of the connectors is known, it can then be replaced in the digital representation in the data set by the storage of a connection that exists between the symbols respectively connected to the connectors. Thus, the different graphs are gradually unified to an overall graph by elimination of connectors associated with one another.

The tracing of the open connections as described can herein be implemented efficiently as a stack structure. During the vectorization or text recognition, a type of table of contents is herein created, from which it is apparent which (unambiguous) identifiers belong to which page. In this way, when tracing connectors, the relevant page is opened directly and investigated. In the event that an identifier is not or is falsely recognized, all the pages are naturally investigated nonetheless.

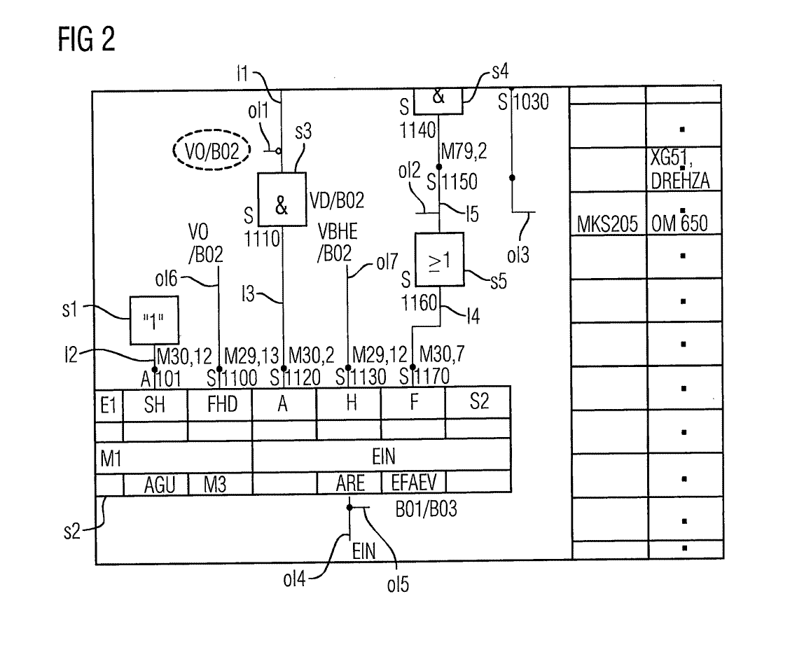

FIG. 2 shows, by way of example, a portion, of a technical drawing 2. The technical drawing 2 has symbols s1 . . . s5 which are partially connected to one another by lines l1 . . . l5. The symbols s1 . . . s5 correspond to technical components with different numbers of connections and, according to the conventions of technical drawing, are shown with a corresponding pictorial representation. Their precise form is of less relevance, however, for the following description.

The lines l1 . . . l5 connected on both sides correspond to signal connections between the respective components which are represented by the symbols s1 . . . s5. The technical drawing 2 also comprises open lines ol1 . . . o17. These always originate from at least one symbol s1 . . . s5 either directly or via a connected line l1 . . . l5, from which they branch and have an open end point. These open lines ol1 . . . o17 stand for connections to other technical drawings 2 or other pages of the technical drawing 2, which are not shown in FIG. 2. Both the open and connected lines ol1 . . . o17, l1 . . . l5 are assembled from portions that extend either vertically or horizontally.

The respective reference, which indicates to the observer where the connection of an open line ol1 . . . o17 is to lead, is given in text form in the region of the open end point. By way of example for illustration, the reference of the horizontal leftwardly open line ol1 in the upper left image portion of FIG. 2 is herein enclosed in a dashed oval. It reads “V0/B02” and is arranged in the extension of the open line oil adjacent thereto and to its left. This means that the reference points to a signal with the identification “V0” on the page “B02”.

The other open lines ol1 . . . o17 have exactly such references which, depending on orientation and type, are arranged at a particular site in the region of the respective open end. Herein, however, apart from the references, many further textual identifiers are arranged in the technical drawing 2, such as identifiers of junction points of the components at the corresponding symbols s1 . . . s5 or labels as parts of the symbols s1 . . . s5 themselves.

In order to determine the references automatically from the large number of labels and to also allocate them in the manner described above to unify the digital images of the technical drawings 2 stored as a graph, a plurality of steps are necessary, as described below, making reference to the other figures.

The expert knowledge relating to the conventions of the respective technical drawing 2, i.e., any knowledge that is necessary for the understanding of the references of the technical drawing 2 is formalized and made available in ontology data. This ontology data is created according to the relevant use, i.e., the ontology data differs depending on the actual usage case. Herein, firstly the possibilities arising in principle for references differ, for example, a first differentiation between global and local signals. Global signals are those that also arise outside the respective structure described, by the technical drawing 2 (e.g., earth potential (GND)), Local signals are those that arise only within the structure. These can be referenced and arranged differently in technical drawings 2. Furthermore, references can be different according to incoming and outgoing signals.

For each of these differentiations, for which references are of a different local or structural nature, an ontology expression is placed in the ontology data, within which the properties of the respective type of reference are stored, as property data of the ontology expression. This comprises data for localizing the pattern search region in which the label, i.e., the reference, is sought, data on the structure thereof, etc.

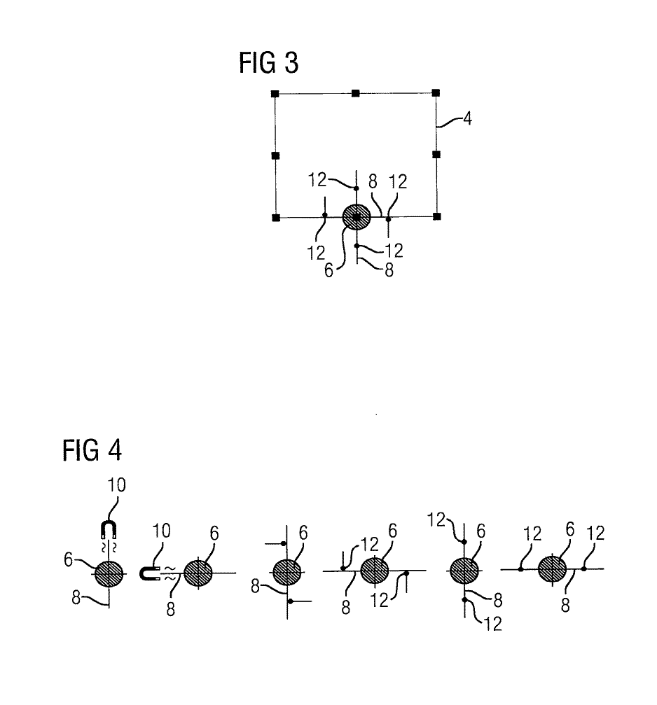

In the present exemplary embodiment, pattern search regions 4 are defined in relation, to the anchor points S, as shown in FIG. 3. FIG. 3 shows a rectangular pattern search region 4 with its anchor point 6 for the exemplary ontology expression “local input reference” defined for the technical drawing 2 in FIG. 1, where this does not have to be the only pattern search region 4 and anchor point 6 that is defined for this ontology expression.

The pattern search region 4 of FIG. 3 is rectangular with a pre-set width, and height stored in the property data. Here, the anchor point 6 is arranged in the center of one of the longer sides of the rectangle and is intersected in FIG. 3 by two orthogonal lines 8 that cross in the anchor point 6. One of the lines lies herein on the longer side of the rectangle. The lines 8 are intended to make clear that, apart from the coordinates of the anchor point 6, its orientation is also relevant.

The anchor point 6 is used for the definition of the pattern search region 4 in the technical drawing 2. With the arrangement of an anchor point 6 and its orientation, the pattern search region. 4 is thus defined. The arrangement of the respective anchor point 4 occurs with the aid of the lines 8, which are brought into coincidence with corresponding lines B in the technical drawing 2, i.e., for each open lines ol1 . . . o17, two orthogonal lines 8 in the technical drawing 2 are determined, at the crossing point of which the anchor point 6 is localized and oriented, so that for each open line ol1 . . . o17, a pattern search region 4 is thus defined.

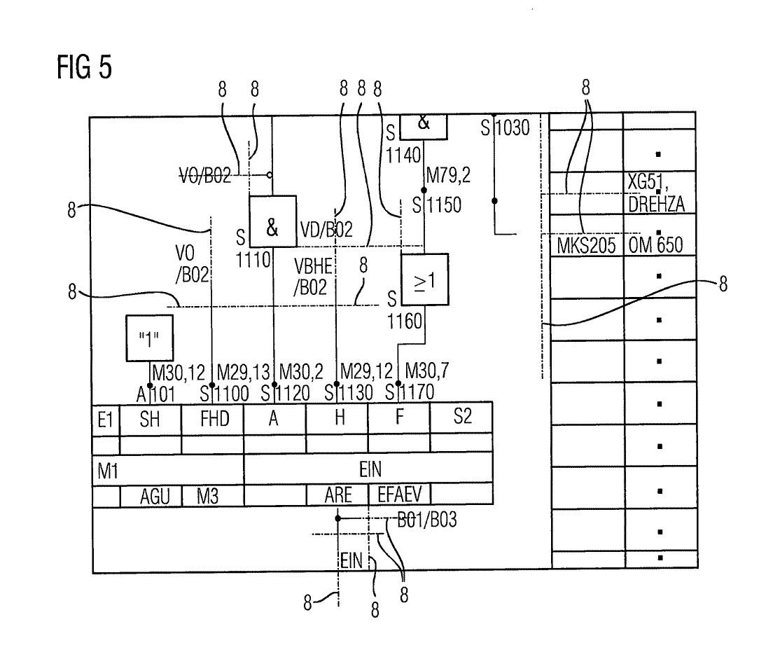

In the exemplary embodiment, there is a plurality of possibilities of the definition of such lines 8, which are partially shown in FIG. 4. From left to right, FIG. 4 shows different possibilities symbolically. Firstly, the closest vertical line 8 originating from the open end point of an open horizontal line ol1 . . . o17 can be sought, represented by a vertical line with a magnet symbol 10.

Further, the closest horizontal line 8 originating from the open end point of an open vertical line ol1 . . . o17 can be sought, represented by a horizontal line 8 with a magnet symbol 10. In the four right-hand representations of FIG. 4, different possibilities are shown for finding lines 8 directly adjoining the open end point of the open lines ol1 . . . o17 herein, where the open end point is symbolized as a point 12 with an adjoining line.

Initially, a vertical normal directly at the leftwardly or rightwardly open end point to the open line ol1 . . . o17 can be used as the line 8. Additionally, a horizontal normal directly at the upwardly or downwardly open end point to the open line ol1 . . . o17 can be used as the line 8. Finally, extensions of the open end point upwardly/downwardly (vertical line 8) or leftwardly/rightwardly (horizontal line 8) can be used.

Further, it is possible (not shown), for example, to create lines 8 at a fixed position in the technical drawing 2 that are used for connectors, for example, a vertical line at 12.3 cm from the left of the technical drawing.

Referring back to FIG. 3, this means for the example of the local input reference and the pattern search region 4 shown in FIG. 3 and the anchor point 6 in the interpretation according to FIG. 4 that for the anchor point S shown there, a horizontal line 8 that forms a normal to an open end point of an open line ol1 . . . o17 must cross a vertical line 8 that represents an extension of the open end point upwardly/downwardly. If such a crossing is found, an anchor point 6 is set with a corresponding pattern search region 4 of the ontology expression “local input reference”. Other ontology expressions can contain other crossing definitions and for the ontology expression “local input reference”, further crossing definitions can also be stored, with a corresponding anchor point 6 and an associated pattern search region 4.

The further sequence of the method 1 is shown in FIG. 5, Initially, all line patterns that are defined in the ontology for the technical drawing 2 are inserted into the technical drawing 2, i.e., in the present exemplary embodiment, normals and extensions on connector ends, the defined lines 8 of fixed position, and the like.

Thereafter, from the line crossings arising, as examples for the named ontology expression “local input reference” those line crossings which correspond to the definition stored there are determined, i.e., a horizontal line 8 that forms a normal to an open end point of an open line ol1 . . . o17 that crosses a vertical line 8 which represents an extension of the open end point upwardly/downwardly (see FIG. 3).

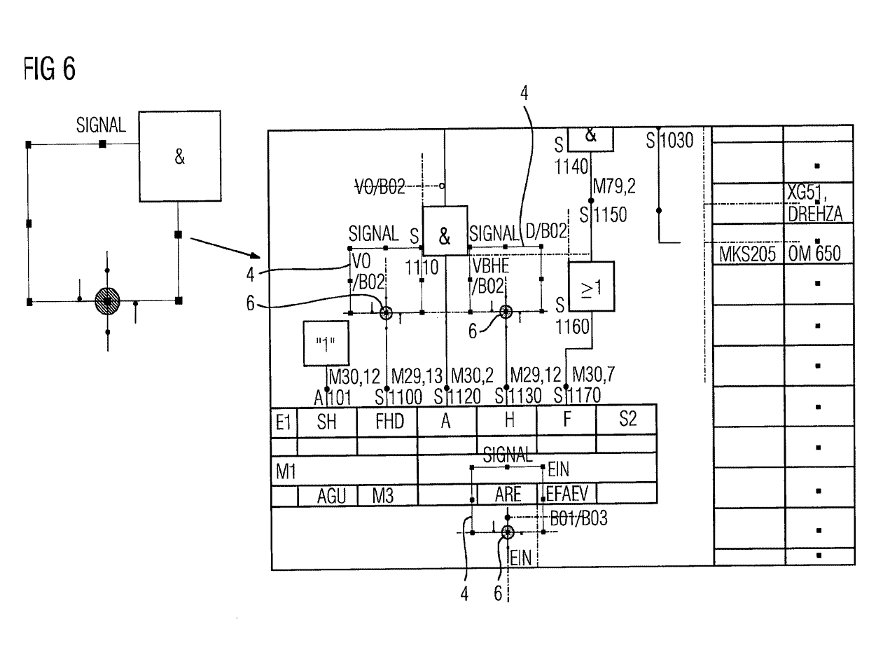

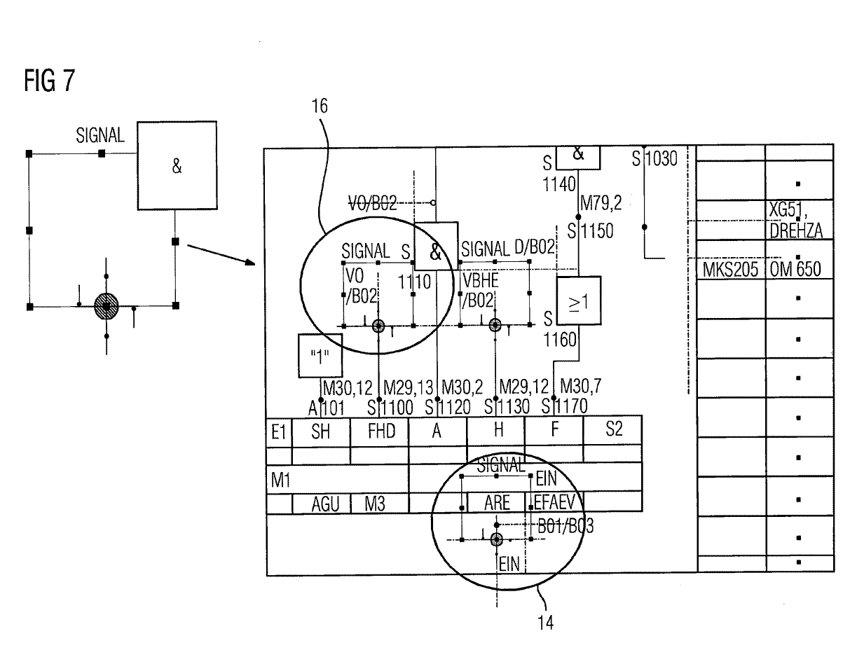

All the crossings found are then provided with a corresponding anchor point 6 of the ontology expression “local input reference”, which thus also directly defines a pattern, search region 4 for each anchor point 6. The three anchor points 6 found for the portion of the technical drawing 2 of the exemplary embodiment with pattern search regions 4 at the open lines ol1 . . . o17 are shown in FIG. 6, with two in the upper region and one in the lower region.

Subsequently, as shown in FIG. 1, the pattern search regions 4 are now restricted based on already recognized symbols s1 . . . s5 in the drawing and also already recognized references, because these are already known from the recording. Thus, the pattern search region 4 in the lower region 14 indicated by an oval is omitted because it is almost entirely covered by the symbol s2 and the adjacent open line ol4.

The pattern search region 4 in the upper region 16 also represented by en oval is restricted on the basis of the symbol s3, i.e., the part of the technical drawing 2 included by the symbol s3 is excluded, from the pattern search region 4, This is shown in the enlarged representation of the pattern search region 4 arranged at the left.

Once the pattern search regions 4 for the respective open end points of the open lines ol6 and ol7 have been defined, in this manner, the references here that are recognizably to be identified as “V0/B02” and “VBHE/B02” are sought by text recognition. For the above described allocation, the semantics of these references must be known in the method 1. This takes place textually for the references shown in the exemplary embodiment by definition of reference patterns, i.e., pattern definitions, which will be described below.

With a markup language (XML in the present example), properties are given for parts of the defined reference pattern and stored under the relevant ontology expression. The definition of a property is constructed as follows;

<p property=“xyz”>regular expression</p>

The reference pattern in a pattern search region 4 can herein consist of a plurality of portions for which different respective properties are defined, or property groups can be defined. With this, complex tree-like structures can be constructed for patterns. The following example belongs to the anchor point for the described local input frequency and illustrates the power of the method;

```
<p compulsory=“true” name=“signal_in”
connect_to=“signal_out ”>
  [A-Z0-9+-] {1,10}
</p>
<group n=“*”>
  <p name=“slash ”>
    [/]
  </p>
  <p name=“page” type=“page”>
    [A-Z0-9] {1, 5}
  </p>
</group
```

Next, in the example above, a reference pattern is defined for the signal name. This is stored in the system under the freely selectable name “signal_in”. According to the given regular expression, the name may consist of capital letters and digits and the characters “+” and “−”. After the signal name, a group follows which consists of the character “/” and an identifier for the page.

For the occurrence of the group, different quantifiers can be selected for regular expressions (n=“*” means that the group can occur as often as desired or not at all).

The reference pattern would, for example, match the character string XS09/3A/5/6 and select XS09 as the signal name and 3A, 5 and 6 as auxiliary names. The fact that XS09 is the element with which a connection to another page is created is expressed, by the presence of the property “connect_to”. This means that the method 1 conversely attempts to find an element with the name “signal_out” and then compares the instances recognized.

If these are identical (i.e., matching text or the same image), the reference is replaced by a connection. With the property type=“page”, a communication is provided to the system that the pattern for the counterpart to the reference is to be found on a page with the found name (i.e., in the example on pages 3A, 5 and 6). If this is not found, then an appropriate notification can be output to the user. If this information is lacking, then the system must search through all the other pages to find the counterpart site for the reference.

Fox the signal name, the property compulsory=“true” has been given above. This means that the overall instance is invalid provided no signal name is found for the instance. Conversely, it is not problematic if no page name has been found. In this case, as mentioned above, all the other pages must be searched through.

The pattern definition above was defined for the text in an individual pattern search region 4 from an anchor point 6. In the same way, it would be possible to specify the pattern at a plurality of regions from one or more anchor points 6. If a separate anchor point 4 is defined, for example, for the signal name and a further anchor point for the page name, these can occur entirely independently of one another on the page and are nevertheless flexibly combined.

In the manner described, the method enables a flexible automated recognition of references in technical drawings 2 and thus an automated connection of their digital images.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-13. (canceled)

14. A computer system Implemented method for automatically establishing a data set characterizing two technical drawings having symbols and lines joining the symbols, from the technical drawings, the method comprising:
a) scanning the technical drawings;
b) identifying a symbol in a first scanned technical drawing and storing a node representing the symbol in the data set;
c) Identifying an open line in the first scanned technical drawing originating from the symbol, a first connector being associated with an open end point of the open line and being stored in the data set;
d) identifying a pattern characterizing the open end point in a defined pattern search region and associating the pattern with the first connector; and
e) associating the first connector with, a second connector of a second technical drawing based on the associated patterns for the first connector and the second connector.

15. The method as claimed in claim 14, wherein the association of the first connector with the second connector is replaced in the data set by storage of a connection wherein the connection exists between the symbol and the symbol from the second technical drawing from which the open line with the open end point originates, which is associated with the second connector,

16. The method as claimed claim 14, wherein ontology data is provided which comprises a plurality of ontology expressions with respectively associated property data; and wherein one of the ontology of the plurality of ontology expressions is associated with the connector.

17. The method as claimed in claim 16, wherein the property data contains a plurality of anchor points with respectively associated anchor localization data which contains a localization of a respective anchor point in relation to the open end point of the open Hoe in the technical drawing.

18. The method as claimed in claim 17, wherein the anchor localization data contains definitions for a vertical and a horizontal line, at an intersection point of which the anchor point is localized, the definitions being selected from the following possibilities:
a line at a fixed position,
a closest line in relation to the open end point,
a normal at the open end point of the open line, and
an extension of the open line.

19. The method as claimed in claim 17, wherein the property data contains a plurality of the defined pattern search regions with respectively associated pattern localization data which contains a localization of a respective pattern search region in relation to the respective anchor point.

20. The method as claimed in claim 18, wherein the property data contains a plurality of the defined pattern search regions with respectively associated pattern localization data which contains a localization of a respective pattern search region in relation to the respective anchor point

21. The method as claimed in claim 16, wherein the property data contains pattern definitions for patterns to be sought in the respective pattern search region.

22. The method as claimed in claim 19, wherein the property data contains pattern definitions for patterns to be sought in the respective pattern search region.

23. The method as claimed in claim 19, wherein the respective pattern search region d on previously recognized patterns.

24. The method as claimed In claim 14, further comprising:
identifying all symbols In the technical drawing and storing a respective node representing each identified symbol in the data set; and
identifying lines respectively connecting at least two symbols in the technical drawing and storing connections representing the respective line in the data set, at least two end points being associated with each connection and one node of the plurality of nodes which represent the symbols connected by the respective line being associated with each end point.

25. The method as claimed in claim 19, wherein the respective pattern search region is restricted based on at least one of previously recognized symbols and lines.

26. The method as claimed in claim 22, wherein the respective pattern search region is restricted based on at least one of previously recognized symbols and lines.

27. The method as claimed in claim 16, wherein the property data comprises information which determines which ontology expression must be associated with the second connector, such that an association of the first to the second connector is permitted.

28. A non-transitory computer program product which is loadable directly into internal memory of a computer and comprises software code portions which, when executed on the computer, causes automatic establishment of a data set characterizing two technical drawings having symbols and lines joining the symbols, from the technical drawings, the software code comprising:
a) program instructions for scanning the technical drawings;
b) program instructions for identifying a symbol in a first scanned technical drawing and storing a node representing the symbol in the data set;
c) program instructions for identifying an open line in the first scanned technical drawing originating from the symbol, a first connector being associated with an open end point of the open line and being stored in the data set;
d) program instructions for identifying a pattern characterizing the open end point in a defined pattern search region and associating the pattern with the first connector; and
e) program instructions for associating the first connector with a second connector of a second technical drawing based on the associated patterns for the first connector and the second connector.

29. A computer system comprising a scanner and an internal memory into which the non-transitory computer program product as claimed in claim 25 is loaded.
